(19) United States
(12) Patent Application Publication
(10) Pub. No.: US 2007/0201699 A1
(43) Pub. Date: Aug. 30, 2007

(54) BROADCAST RECEIVER AND BROADCAST RECEIVING METHOD

(75) Inventor: Takuya Kasuya, Osaka (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/678,145

(22) Filed: Feb. 23, 2007

(30) Foreign Application Priority Data
Feb. 28, 2006 (JP) 2006-051710

(51) Int. Cl. H04K 1/00

(52) U.S. Cl. 380/258

(57) ABSTRACT

When a broadcasting station transmits an application including an authentication key enabling use of a program recommendation engine or the like together with a program, a broadcast receiver identifies the application including the authentication key from other applications. When the application including the authentication key is received, the authentication key is extracted. When a CableCARD is inserted, an individual number included in the CableCARD is extracted. Authentication is performed using the authentication key and individual number, and the program recommendation engine is executed when it can be authenticated that execution of the program recommendation engine or the like is enabled.

### BACKGROUND OF THE INVENTION

1. Field of the Invention

The present invention relates to a broadcast receiver including an authentication unit for executing secure software such as an original technology built in middleware, and a broadcast receiving method.

2. Background Art

Conventionally, North American Open Cable Application Platform (OCAP) Standard (registered trademark) defines middleware so as to absorb hardware difference between broadcast receiver manufacturers and provide the same service with any hardware. North American OCAP Standard is developed by North American Cable Television standardization organization based on European digital TV standard Digital Video Broadcasting Multimedia Home Platform (DVB-MHP) (registered trademark). Hereinafter, this standard is simply referred to as “OCAP Standard”. Using the OCAP Standard, a broadcasting station muliplexes application software for performing various applications into broadcast wave, and transmits it. Each broadcast receiver executes a new application by downloading the application multiplexed to the broadcast wave. An example of the broadcast receiver for executing a new application by downloading the application is disclosed in Japanese Translation of PCT Publication No. 2001-516532. An example of user authentication in such application execution is disclosed in Japanese Patent Unexamined Publication No. 2002-41467. Thus, in addition to a video/audio digital broadcast, a digital CATV can achieve bidirectional service and Internet service.

However, each broadcast receiver manufacturer is required to provide a new function that is not included in middleware for a user in order to achieve a function specific to each broadcast receiver. In such a case, an application (hereinafter referred to as “original application”) such as a program recommendation engine that is not included in the OCAP Standard needs to be multiplexed as one application to broadcast wave and to be transmitted. In this case, there is a risk that an application production company or a company having received the application leaks the original technology of each manufacturer, such as the program recommendation engine, during application analysis.

### SUMMARY OF THE INVENTION

The present invention prevents leakage of an original technology of each manufacturer, such as a program recommendation engine, and allows secure execution of the program recommendation engine.

For that purpose, a broadcasting station transmits an application including an authentication key enabling an original application together with a program, and a broadcast receiver identifies the application including the authentication key from other applications in the present invention. When the broadcast receiver receives the application including the authentication key, the broadcast receiver performs authentication using the authentication key extracted with an extracting function thereof. When a CableCARD (registered trademark) is inserted, the individual number recorded on the CableCARD is used for the authentication. Only when the authentication result shows that execution of the program recommendation engine is enabled, the received application can be executed using the original application.

Thus, the broadcast receiver of the present invention including a use authentication unit of a program recommendation engine or the like is enabled to execute the program recommendation engine, only in the following case: the broadcast receiver receives an application including an authentication key for executing the program recommendation engine, extracts the authentication key from the application, and determines that the program recommendation engine is enabled based on the extracted authentication key and the individual number of the broadcast receiver. Therefore, a problem where an unauthorized user analyzes an application and acquires an original technology included in secure software can be prevented.

### BRIEF DESCRIPTION OF DRAWINGS

FIG. 1 is a block diagram showing a configuration of a broadcast receiver and a broadcast receiving system in accordance with a first exemplary embodiment of the present invention.

FIG. 2 is a structural drawing of transmitted broadcast wave in accordance with the first exemplary embodiment.

FIG. 3 is a data analysis flowchart of an application receiving unit in accordance with the first exemplary embodiment.

FIG. 4 is a data analysis flowchart of an authentication key verifying unit in accordance with the first exemplary embodiment.

FIG. 5 is a diagram showing a structure of an XAIT 200 in accordance with the first exemplary embodiment.

FIG. 6 is a flowchart showing an operation of the broadcast receiver in accordance with the first exemplary embodiment.

FIG. 7 is a block diagram showing a configuration of a broadcast receiver and a CATV system in accordance with a second exemplary embodiment of the present invention.

### DETAILED DESCRIPTION OF THE INVENTION

Broadcast receivers of exemplary embodiments of the present invention will be described with reference to the drawings. In the exemplary embodiments, a program recommendation engine is described as an example of the original technology included in secure software.

### First Exemplary Embodiment

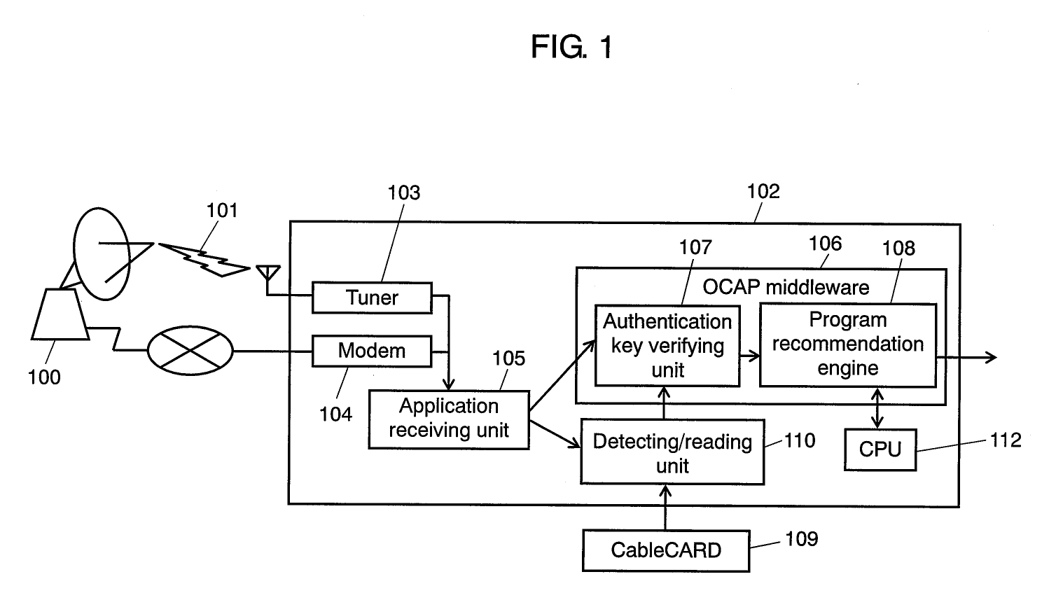

FIG. 1 is a block diagram showing a configuration of broadcast receiver 102 including program recommendation engine 108 and a broadcast receiving system including broadcast receiver 102 in accordance with exemplary embodiment 1 of the present invention.

In exemplary embodiment 1, the whole broadcast receiving system has broadcasting station 100, broadcast wave 101, and broadcast receiver 102. Broadcast receiver 102 has tuner 103, modem 104, application receiving unit 105, OCAP middleware 106, authentication key verifying unit 107, program recommendation engine 108, CableCARD 109, detecting/reading unit 110, and CPU 112. Broadcast wave 101 transmitted from broadcasting station 100 includes an application including an authentication key.

Broadcast receiver 102 has both tuner 103 and modem 104 in embodiment 1; however, broadcast receiver 102 does not need to have both of them and may have only one of them. Tuner 103 and modem 104 correspond to a receiving unit of the present invention. In embodiment 1, authentication key verifying unit 107 corresponds to an authentication key determining unit of the present invention that authenticates enablement of program recommendation engine 108.

Broadcasting station 100 transmits an application that has been multiplexed into broadcast wave 101 and includes an authentication key required for executing program recommendation engine 108, similarly to other applications. Broadcast receiver 102 receives broadcast wave 101 with tuner 103 and modem 104, and transmits received information to application receiving unit 105. This application uses program recommendation engine 108 as the secure software including the original technology. This application includes an authentication key indicating that the application has an authorized right to use the program recommendation engine. Further, program recommendation engine 108 is previously included in OCAP middleware 106 of broadcast receiver 102.

In embodiment 1, application receiving unit 105 also serves as an identifying unit and extracting unit of the present invention. Therefore, application receiving unit 105 always monitors whether an application including an authentication key exists in the information transmitted from tuner 103 and modem 104. When application receiving unit 105 identifies that there is an application including an authentication key, it extracts the authentication key from the application including the authentication key, and transmits the authentication key to authentication key verifying unit 107.

Authentication key verifying unit 107 in OCAP middleware 106 previously holds an individual number specific to broadcast receiver 102 as information for verifying the authentication key, and collates the authentication key transmitted from application receiving unit 105 with the previously held individual number. Only when the collation result is correct, CPU 112 corresponding to the processing unit of the present invention is enabled to execute program recommendation engine 108.

Alternatively, on detecting that CableCARD 109 is inserted into broadcast receiver 102, detecting/reading unit 110 reads the individual number previously stored in the CableCARD. In other words, detecting/reading unit 110 of the present embodiment serves as a detecting unit and reading unit of the present invention. Detecting/reading unit 110 transmits the read individual number to authentication key verifying unit 107. Authentication key verifying unit 107 performs collation based on this individual number. When the collation is established, CPU 112 executes the application using program recommendation engine 108. Software enabled by the application including the authentication key is not limited to the program recommendation engine, but may be some secure software stored in OCAP middleware 106.

The read individual number is a number specific to the broadcast receiver, namely a unique number, and is stored in a non-volatile memory or the like built in the broadcast receiver. Such a number is a serial number of the broadcast receiver, a Media Access Control (MAC) address, or other unique number, for example. When the CableCARD is used as discussed above, the number may be stored in the CableCARD. Here, “unique” means that the number is the only one in the world.

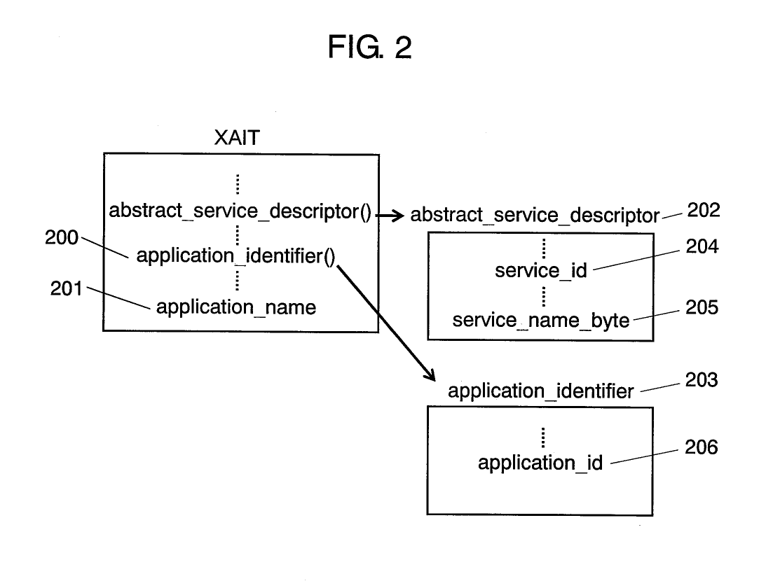

The present embodiment is described in detail with reference to FIG. 1 through FIG. 5 and the OCAP Standard. FIG. 2 is a structural drawing of transmitted broadcast wave 101 in accordance with the present exemplary embodiment.

Broadcasting station 100 transmits information of each program of broadcast wave 101 and other information together with a video signal, an audio signal, and XAIT 200 as program additional information defined by the OCAP Standard. In XAIT 200, application_name 201, abstract_service_descriptor 202 for determining service_id 204 and service_name_byte 205, and application identifier 203 for determining application_id 206 are arranged.

Here, application_name 201 shows the application name transmitted from broadcasting station 100, abstract_service_descriptor 202 shows service information or the like of each application, and application_identifier 203 shows an application identifier. Service_id 204 is a value used for identifying the service under transmission, and can be specified from a certain range by either of the broadcasting station and the receiver manufacturer. Here, the range is different between the broadcasting station and the receiver manufacturer. Service_name_byte 205 is information used for identifying the service name under transmission, and application_id 206 is a value used for identifying the application under transmission.

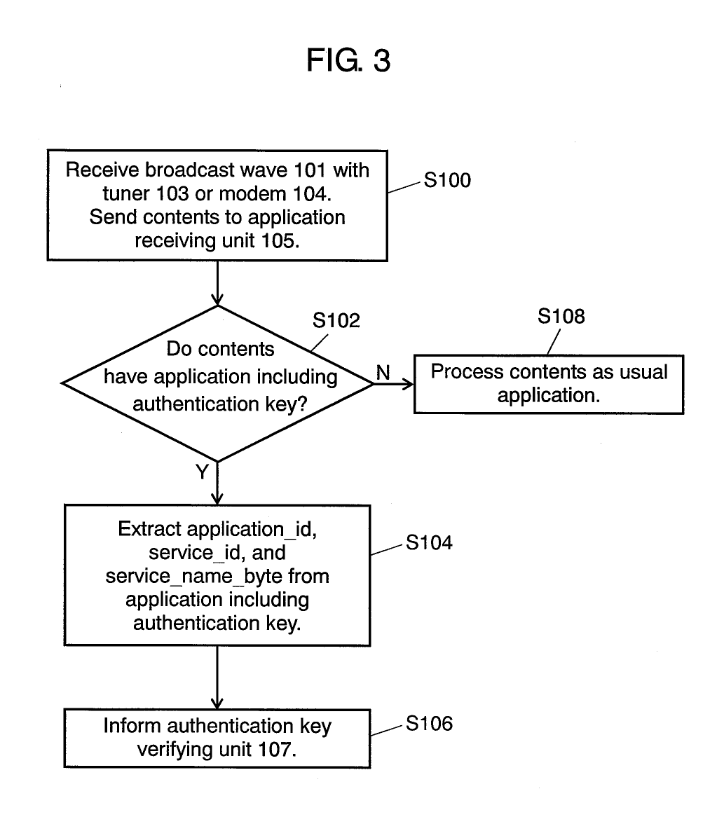

An operation of application receiving unit 105 of the present embodiment is described hereinafter with reference to FIG. 3. Broadcast wave 101 that is obtained by multiplexing the application including the authentication key and transmitted from broadcasting station 100 is received in a receiving step executed by tuner 103 or modem 104 of broadcast receiver 102 (the first half of S100). The received broadcast wave is transmitted from tuner 103 or modem 104 to application receiving unit 105 (the latter half of S100).

Application receiving unit 105, in the identifying step, retrieves application_name 201 from XAIT 200 in the transmitted stream multiplexed into broadcast wave. When information allowing the name shown in application_name 201 to be identified to indicate the application including the authentication key is previously stored in a storage medium of broadcast receiver 102, application receiving unit 105 can identify that the received application is the application including the authentication key (S102).

In another embodiment, broadcast receiver 102 can also identify that the received application is an application including the authentication key by adding flag information to broadcast wave 101 transmitted from broadcasting station 100. Here, the flag information shows that broadcast wave 101 corresponds to the application including the authentication key.

On identifying that the received application is the application including the authentication key in the identifying step, application receiving unit 105 extracts service_id 204, service_name_byte 205, and application_id 206 from XAIT 200 in the extracting step (S104). Application receiving unit 105 then sends the extracted contents to authentication key verifying unit 107 in OCAP middleware 106 (S106).

When the application including the authentication key is identified in the identifying step but all of three pieces of information are not extracted, dummy information such as “−1” is set instead of the information that is not extracted and sent to authentication key verifying unit 107. Applications other than the application including the authentication key are not sent to authentication key verifying unit 107, but directly sent to OCAP middleware 106 (S108).

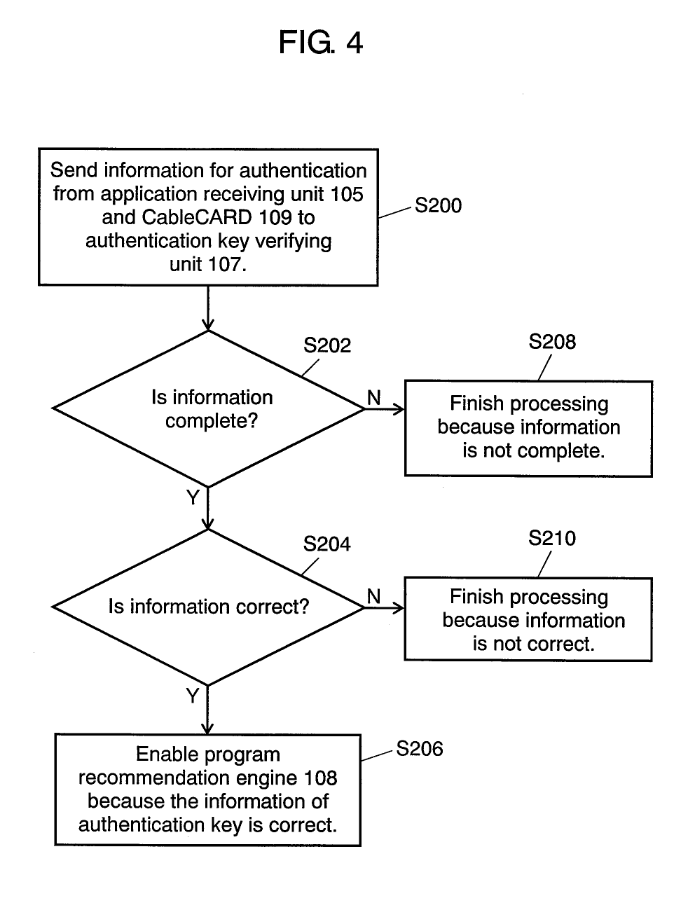

Next, an operation of authentication key verifying unit 107 of the present embodiment is described with reference to FIG. 4. Application receiving unit 105 extracts service_id 204, service_name_byte 205, and application_id 206 from the application including the authentication key, and sends them to authentication key verifying unit 107 (S200).

Authentication key verifying unit 107 verifies whether the three pieces of sent information are correct by collating the information sent from application receiving unit 105 with information for verification in the authentication key verifying step (S202, S204). Here, the information for verification is previously stored in the storage medium of broadcast receiver 102, for example CableCARD 109. When the collation result shows that all of three pieces of information are correct, middleware 106 is enabled to execute program recommendation engine 108 in the processing step (S206). When all of three pieces of information are not correct, middleware 106 determines that the authentication key is false, and does not execute program recommendation engine 108 (S208, S210).

When the application including the authentication key is upgraded, one or all of three pieces of information (service_id 204, service_name_{—3}byte 205, and application_id 206) can be changed. Even in this case, processing similar to the above-mentioned processing can be performed by previously adding upgraded information to the storage medium of broadcast receiver 102.

When CableCARD 109 is used, the following processing may be performed. CableCARD 109 is inserted into broadcast receiver 102, and then device authentication is executed between the individual number recorded in CableCARD 109 and broadcast receiver 102. When the device authentication is completed normally, the function of CableCARD 109 is enabled. After confirming the transition to this enabled state, a completion signal of the device authentication is transmitted to broadcasting station 100 using tuner 103 or modem 104, and CableCARD 109 receives, from broadcasting station 100, a key showing that program recommendation engine 108 is enabled.

In this case, broadcasting station 100 transmits the individual number or MAC address of CableCARD 109 enabling the execution of program recommendation engine 108, and broadcast receiver 102 determines whether program recommendation engine 108 is enabled by collating the transmitted contents with the individual number or MAC address of actually inserted CableCARD 109.

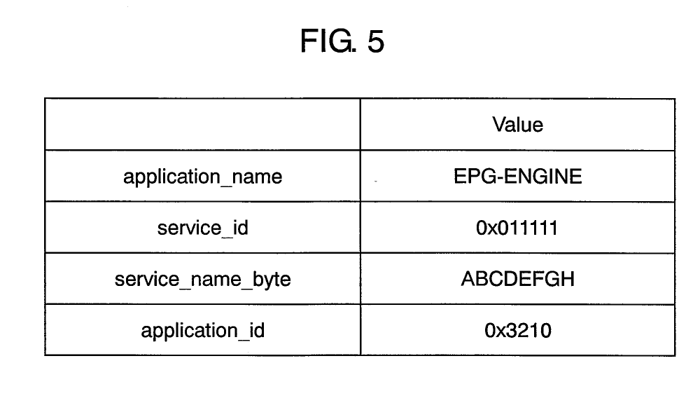

Next, another example of the broadcast receiver of the present invention that has a program recommendation engine is described with reference to FIG. 5. FIG. 5 shows one example of header information XAIT 200 transmitted with broadcast wave 101. Broadcast receiver 102 previously stores “EPG-ENGINE” as application_name 201 which is information used for executing the program recommendation engine, “0x011111” as service_id 204, “ABCDEFGH” as service_name_byte 205, and “0x3210” as application_id 206.

When the same contents as the above contents are set also in XAIT 200 of the stream multiplexed into broadcast wave 101 transmitted from broadcasting station 100, broadcast receiver 102 transmits the received stream to application receiving unit 105 through tuner 103 or modem 104. Application receiving unit 105 searches XAIT 200 for application_name 201, and determines that application_name 201 is “EPG-ENGINE”. Application receiving unit 105 collates this information with the information stored in broadcast receiver 102, determines that this application is the application including the authentication key, and extracts service_id 204, service_name_byte 205, and application_id 206. Application receiving unit 105 sends the extracted information to authentication key verifying unit 107 in OCAP middleware 106.

Authentication key verifying unit 107 verifies that sent service_id 204, service_name_byte 205, and application_id 206 are “0x011111”, “ABCDEFGH”, and “0x3210”, respectively. In other words, they match with the information of the authentication key previously stored in broadcast receiver 102. At this time, program recommendation engine 108 is executed. Thus, the application transmitted from the broadcast wave can execute program recommendation engine 108.

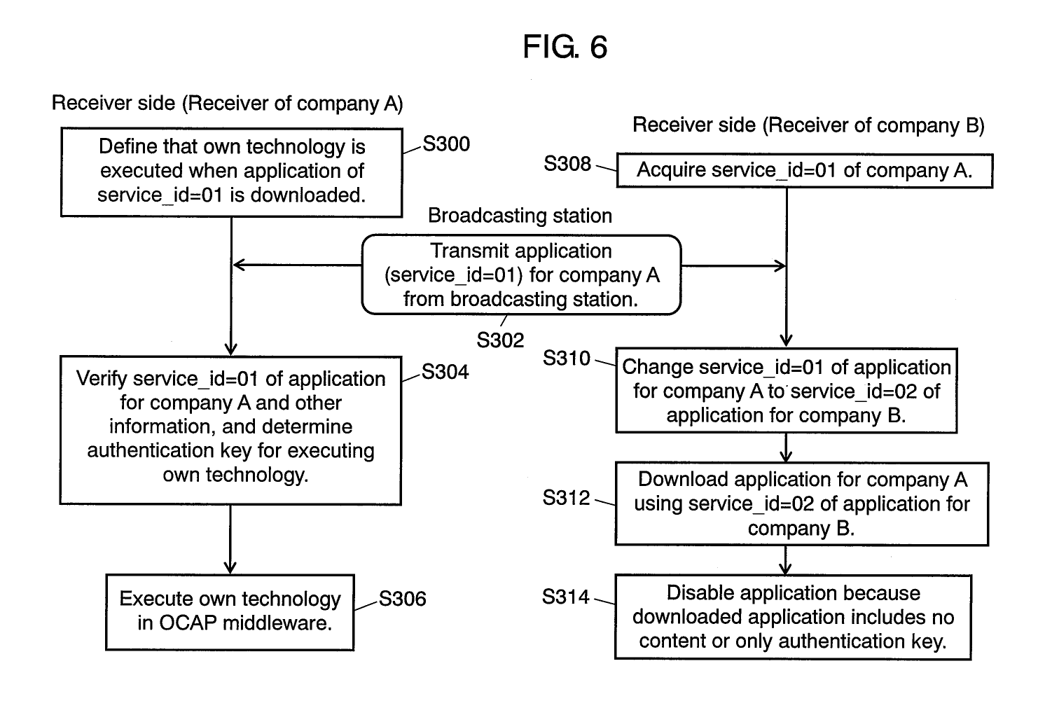

A specific operation of the broadcast receiver performed when a broadcasting station transmits an application for company A is described hereinafter with reference to FIG. 6. Here, it is assumed that the service_id of the application for company A is “01” and the service_id of the application for company B is “02”. It is further assumed that, when a downloaded application has service_id of “01”, the OCAP middleware of the receiver of company A executes the application (S300).

An operation of the broadcast receiver of company A that has received the application for company A transmitted from the broadcasting station in the above condition is described. The broadcast receiver of company A having received the application for company A performs authentication based on the information such as the service_id (S304). When the application for company A is authenticated in the authentication step (S304), the broadcast receiver executes an own original technology in the OCAP middleware (S306). Thus, the broadcast receiver of company A is enabled to execute the application for company A transmitted from the broadcasting station.

An operation in the broadcast receiver of company B is described hereinafter with reference to FIG. 6. It is assumed that company B has obtained the service_id of company A in order to analyze the original technology of another company (S308). In other words, in this example, it is assumed that company B has obtained “01” as the service_id information.

An operation of the broadcast receiver of company B that has received the application for company A transmitted from the broadcasting station in the above-mentioned condition is described. The broadcast receiver of company B having received the application for company A changes the service_id of the application for company A from “01” to “02” so as to enable the application for company A to be executed in the broadcast receiver of company B (S310). The broadcast receiver of company B then downloads the application for company A in the state where the service_id is “02” (S312). In this case, however, the stored service_id does not match with the service_id included in the application, so that the broadcast receiver of company B is not enabled to execute the application for company A or analyze the contents of the application.

Thus, the present invention can prevent leakage of the own original technology such as a program recommendation engine, and can securely execute the program recommendation engine.

The application related to the program recommendation engine has been described; however, the present invention is not limited to this, but can be applied to other engines and applications.

The example of the CableCARD has been described; however, the present invention is not limited to this, but can be attained with an application having an authentication function without using a physical CableCARD.

The present embodiment is one effective example of the present invention; however, the present invention is not limited to this, but the embodiment can be varied in a scope that does not depart from the outline of the present invention.

As discussed above, the broadcast receiver of the present invention including a use authentication unit such as a program recommendation engine simply needs to receive an authentication key in order to execute the program recommendation engine or the like, and can prevent leakage of the own original technology such as the program recommendation engine.

### Second Exemplary Embodiment

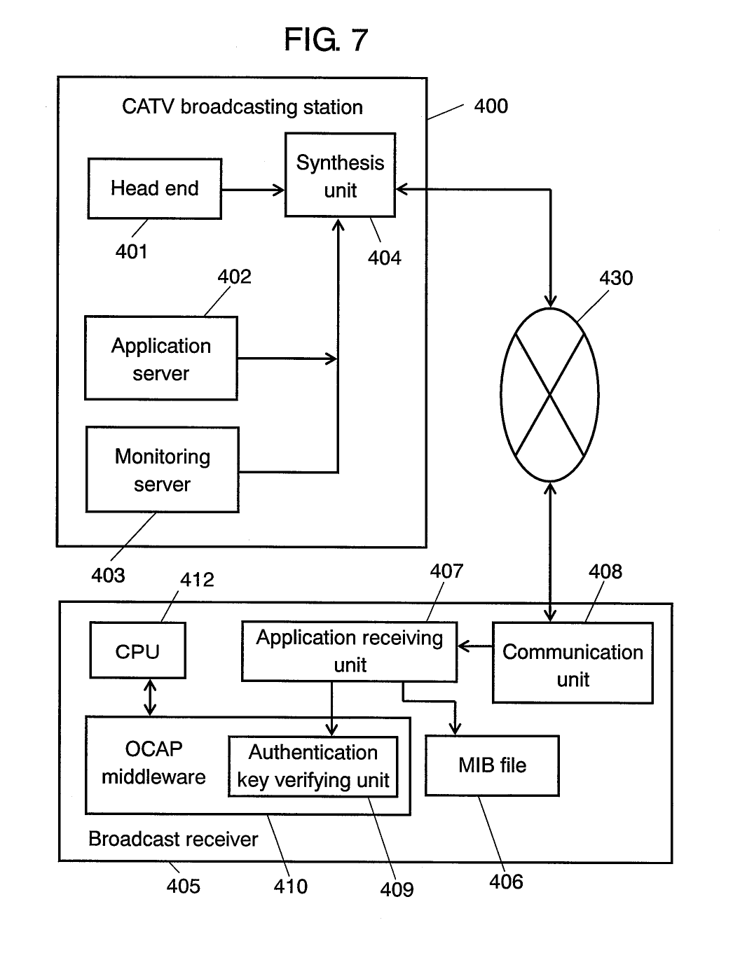

FIG. 7 is a block diagram showing a configuration of a broadcast receiver and a CATV system in accordance with exemplary embodiment 2 of the present invention. The whole CATV system mainly has broadcast receiver 405 as exemplary embodiment 2 of the present invention, CATV broadcasting station 400, and CATV network 430. CATV broadcasting station 400 mainly has head end 401 for transmitting a video/audio signal, application server 402 for transmitting various application software, monitoring server 403, and synthesis unit 404 for multiplexing the information output from them and transmitting it to CATV network 430. The whole CATV system has many elements in addition to them, but elements that do not directly relate to the essence of the present invention are omitted. Similarly, the CATV broadcasting station has many elements in addition to them, but elements that do not directly relate to the essence of the present invention are omitted. Only one head end 401, only one application server 402, and only one monitoring server 403 are shown in FIG. 7, but there may be more than one, respectively.

Broadcast receiver 405 is broadly similar to broadcast receiver 102 of embodiment 1 of the present invention. Points of similarity between broadcast receiver 405 and broadcast receiver 102 are not described, but only points of difference between them are described.

Broadcast receiver 405 includes communication unit 408, application receiving unit 407, OCAP middleware 410, authentication key verifying unit 409, CPU 412, and Management Information Base (MIB) file 406. Broadcast receiver 405 also has many elements in addition to them, but elements that do not directly relate to the essence of the present invention are omitted.

Communication unit 408 corresponds to tuner 103 and modem 104 of embodiment 1, and bi-directionally communicates video/audio signals, applications, and other information to CATV broadcasting station 400 via CATV network 430.

OCAP middleware 410 may include program recommendation engine 108 as secure software having an original technology, or does not need to include it. However, OCAP middleware 410 needs to some software (not shown) to be kept in a secure state. Similarly, OCAP middleware 410 may include CableCARD 109 storing an individual number and detecting/reading unit 110, or does not need to include them.

Broadcast receiver 405 of embodiment 2 differs from broadcast receiver 102 of embodiment 1 in that broadcast receiver 405 includes MIB file 406. This will be described later in detail.

In the CATV broadcasting system, application server 402 of CATV broadcasting station 400 transmits Java application software including an authentication key for executing the Java application software. Another application server (not shown) is assumed to transmit the Java application software that does not include the authentication key for executing the Java application software and other application software.

These pieces of software are transmitted to synthesis unit 404, and synthesis unit 404 multiplexes them and video/audio signals fed from head end 401 and transmits them to CATV network 430.

Communication unit 408 of broadcast receiver 405 receives the multiplexed video/audio signals and various applications from CATV network 430. As discussed above, communication unit 408 corresponds to tuner 103 and modem 104 of embodiment 1, and receives the multiplexed video/audio signals, various applications, and other information that are fed from CATV broadcasting station 400 via CATV network 430.

The information received by communication unit 408 is sent to application receiving unit 407.

Similarly to application receiving unit 105 of embodiment 1, application receiving unit 407 always monitors whether the information received by communication unit 408 includes a multiplexed application including an authentication key. In other words, application receiving unit 407 corresponds to the identifying unit of the present invention.

On identifying that the Java application including the authentication key is received, application receiving unit 407 of broadcast receiver 405 searches for received recording information of the MIB file, and verifies whether the Java application including the authentication key has been received before. Here, Management Information Base (MIB) is defined by Simple Network Management Protocol (SNMP), namely one of network protocols, and monitors a network apparatus.

If the Java application including the authentication key has been received before and it is previously recorded that the Java application is enabled to be executed, application receiving unit 407 informs authentication key verifying unit 409 of this fact. Thus, CPU 412 corresponding to the processing unit of the present invention is enabled to execute the Java application including the authentication key using secure software included in OCAP middleware 410.

If the Java application including the authentication key has not been received before, application receiving unit 407 informs the CATV broadcasting station of the reception of the Java application including the authentication key using a Trap as a spontaneous interrupt signal defined by SNMP, one of network protocols. At this time, an informing signal showing the reception is transmitted from communication unit 408 to CATV broadcasting station 400. The informing signal includes information showing that broadcast receiver 405 receives the Java application including the authentication key, and information of the individual number of broadcast receiver 405, and other information. The informing signal is received by monitoring server 403 of CATV broadcasting station 400. In other words, monitoring server 403 of CATV broadcasting station 400 corresponds to a center server device of the present invention.

Monitoring server 403 receives the informing signal, and determines, based on information included in the informing signal and its own information, whether or not broadcast receiver 405 having transmitted the informing signal is enabled to execute the Java application including the authentication key.

On determining that broadcast receiver 405 having transmitted the informing signal is enabled to execute the Java application including the authentication key, monitoring server 403 transmits, to broadcast receiver 405, an enabling signal indicating that the Java application is enabled to be executed using the received authentication key.

On receiving the enabling signal from monitoring server 403, broadcast receiver 405 transmits the enabling signal to authentication key verifying unit 409. CPU 412 corresponding to the processing unit of the present invention is enabled to execute the Java application including the authentication key using secure software included in OCAP middleware 410. On receiving the enabling signal, application receiving unit 407 updates the received recording information of the MIB file, and records that the Java application including the authentication key has been received and the Java application is enabled.

In embodiment 2 of the present invention, the authentication for executing the Java application is performed by cooperated work including communications between broadcast receiver 405 and monitoring server 403, so that the security is further improved.

What is claimed is:

1. A broadcast receiver comprising:
a receiving unit for receiving broadcast wave;
an identifying unit for identifying an application including an authentication key, the application being multiplexed into the broadcast wave received by the receiving unit;
an extracting unit for extracting the authentication key from the application when the identifying unit identifies the application including the authentication key;
an authentication key determining unit for determining that the authentication key extracted by the extracting unit enables execution of middleware by comparing the authentication key with an individual number of the broadcast receiver; and
a processing unit for executing the middleware when the authentication key determining unit determines that the authentication key enables execution of the middleware.

2. The broadcast receiver of claim 1,
wherein the receiving unit includes one or both of a tuner and a modem.

3. The broadcast receiver of claim 1,
wherein the identifying unit identifies an application using information indicating an application including one of APPLICATION_NAME of OCAP Standard and the authentication key.

4. The broadcast receiver of claim 1,
wherein the identifying unit identifies the application during download of application software.

5. The broadcast receiver of claim 1, further comprising:
a detecting unit for detecting that a CableCARD is inserted; and
a reading unit for reading the individual number from the CableCARD when the detecting unit detects insertion of the CableCARD.

6. The broadcast receiver of claim 5,
wherein the individual number is a unique serial number written in the CableCARD.

7. The broadcast receiver of claim 5,
wherein the individual number is a unique MAC address written in the CableCARD.

8. A broadcast receiver comprising:
a communication unit for receiving a broadcast signal;
an identifying unit for identifying an application including an authentication key, the application being multiplexed into the broadcast signal received by the communication unit; and
a processing unit for executing the application,
wherein the communication unit transmits an informing signal to a center server device when the identifying unit identifies the application including the authentication key,
wherein an enabling signal indicating execution of the application using the authentication key is received from the center server device, and
wherein the processing unit executes the application after reception of the enabling signal.

9. A broadcast receiving method comprising:
receiving broadcast wave;
identifying an application including an authentication key, the application being multiplexed into the broadcast wave received in the receiving step;
extracting the authentication key from the application when the application including the authentication key is identified in the identifying step;
determining that the authentication key extracted in the extracting step enables execution of middleware; and
executing the middleware when the authentication key is determined to enable execution of the middleware in the authentication key determining step.
